(19) United States
(12) Patent Application Publication
(10) Pub. No.: US 2007/0038507 A1
(43) Pub. Date: Feb. 15, 2007

(54) A system and method for enabling prospects to contact sponsoring advertisers on the telephone directly from an Internet-based advertisement with just a single-click, and efficiently tracking from what Internet location (URL) the telephone contacts are initiated.

(76) Inventor: Gopesh Kumar, Pleasanton, CO (US)

Correspondence Address: JEFFREY FURR, 253 N. MAIN STREET, JOHNSTOWN, OH, 43031, US

(21) Appl. No.: 11/161,682

(22) Filed: Aug. 12, 2005

(51) Int. Cl. G06Q 30/00

(52) U.S. Cl. 705/14

(57) ABSTRACT

The present invention provides a system and method for enabling prospects to contact sponsoring advertisers on the telephone directly from an Internet-based advertisement with just a single-click and provides the ability to track from which Internet location (URL) these telephone calls are generated, thereby enabling a more convenient and efficient telephone call measured, Internet based pay-for-performance advertising platform.

### BACKGROUND OF INVENTION

1. Field of the Invention

The present invention relates to techniques for and the art of Internet-based pay-for-performance advertising, and more specifically to the enabling of a prospect to contact an advertiser directly over telephone lines with just a single-click from an Internet-based advertisement, and the efficient tracking of the Internet-based source location (URL) of the incoming telephone call.

2. Description of Prior Art

One early method of Internet advertising, and one that persists today, is directory listings wherein advertisers pay flat monthly or annual fees for inclusion in an Internet-based directory. This kind of advertising is non-performance based since the fees remain the same regardless of any customer actions (such as ‘click-throughs’ to an advertiser website, telephone calls to advertiser's business or sales of an advertiser's product or service) that are taken as a result of the advertising listing.

Later, impression-based banner advertising became a popular method of Internet advertising. In this method, advertisers are charged by the number of impressions, or times an advertisement is displayed to or viewed by potential customers. Although somewhat closer in spirit to pay-for-performance advertising, this method is not truly pay-for-performance either since the fees to an advertiser are again in no way linked to any desired action taken by a potential customer.

Recently, actual pay-for-performance advertising services have emerged and become very popular on the Internet. The most prevalent of such performance based advertising is ‘pay-per-click’ or paid search, wherein advertisers pay only when prospects ‘click through’ their advertisements and onto the advertiser's website or other web presence. There is no cost to advertisers for the display of their advertisements (which is usually linked to a consumer search for a relevant or applicable keyword and/or category in a search engine), but only a cost if a prospect takes the desired action of choosing the advertisement and ‘clicking through’ it to the advertiser's Internet-based property.

One shortcoming of this kind of pay-for-performance advertising is that it requires advertisers to have a website or web presence to which consumers can ‘click through’. Many advertisers do not have a website. Furthermore, many advertisers sell goods and/or services that are not easily sold via the Internet and so, even if they did have a web presence, do not find it useful for a potential customer to ‘click-through’ to a website. Many of these advertisers instead find incoming phone calls more useful.

However, these ‘pay-per-click’ performance based advertising vehicles are not designed to attract phone calls from prospects to advertisers, and further are unable to track and log phone calls that may be generated as a result of these advertisements. In turn, they cannot definitively identify incoming calls to businesses that were generated from specific advertisements and so lack the ability to provide a pay-for-performance advertising model based on the performance many advertisers find truly useful and prefer: phone calls from potential customers.

More recently, there is a system available that offers advertisers an Internet-based pay-for-performance advertising model that utilizes the incoming phone call from a potential customer as the performance (and value) metric. It offers a method to monitor, track and charge advertisers for incoming phone calls from potential customers generated from Internet-based advertisements. The system assigns a unique phone number to an advertiser and then displays this phone number in the Internet-based advertisements. Such a system requires a potential customer to first read or write down the phone number from the Internet advertisement and then enter it into their telephones to connect with the Advertiser. This system is limited however in two ways. First, it is simply not convenient for potential customers to call advertisers in this way. Second, if there is more than one unique advertisement URL displaying the advertiser's unique phone number then it is impossible to know precisely from which advertisement the call is generated, which in turn limits the number of unique locations the advertisements with the unique telephone numbers, and resultant incoming phone calls, can be effectively monitored and tracked from to only one. Therefore, to effectively monitor from where a call is initiated from for a single advertiser's advertisement that is displayed through multiple distribution channels, a unique telephone number would have to be created for each unique distribution channel, which is very inefficient.

Consequently, there is a need for a telephone-call-based pay-for-performance advertising system that simplifies the calling process for potential customers and can more efficiently monitor exactly from which Internet-based advertisement location/distribution channel a call was generated. Such a system would make it easier for prospects to call advertisers, and easier to track exactly which advertisements are generating calls in a multiple distribution channel environment. Just such a system, with its inventive framework and its creative methods, is hereinafter described.

### SUMMARY OF CURRENT INVENTION

It is the objective of the current invention to provide a system and method for more convenient and more measurable telephone call-based-pay-for-performance Internet advertising. The present invention remedies the shortcomings of the prior art by allowing callers to connect to advertisers over the telephone by just a single click from a generally distributed Internet-based advertisement, and by providing the capability to efficiently track precisely from which channel, of a multiplicity of Internet-based distribution channels, a unique advertiser's advertisement attracted an incoming call.

Definitions:

Activator Link(Single-Click Activator Link): a graphical or text icon that is linked to this system's database, embedded into this system's Advertisements, and empowered by a unique batch of computer code that enables the immediate telephonic contact between the Advertiser and the Prospect.

Advertisement: a unique design piece intended for distributed publication and display throughout the Internet for advertising purposes with the intention of encouraging consumers/prospects to take some consumer-related action as determined and desired by the Advertiser, in the case of the current invention, an incoming phone call. Advertisements could include banner ads, landing pages, popup windows, emails, directory listings, etc.

Advertiser (Client): a company or entity contracting and paying for the Advertisement.

Browser: a software program that runs on a client host and is used to request Web pages and other data from server hosts. This data can be downloaded to the client's disk or displayed on the screen by the browser.

Call Source URL: The web page, as identified by its universal resource locator (URL) address, from where a system-based telephone call is initiated by a prospect to an advertiser.

Client host: a computer that requests Web pages from server hosts, and generally communicates through a browser program.

Content provider: a person or business responsible for providing the information that makes up a collection of Web pages.

Distribution Channel: An avenue or vehicle for distributing something which, in the case of the current invention, are pay-per-telephone call Advertisements and are composed of Internet-based Publishers and service providers.

Distribution Partner (Publisher)(Channel): a company or entity who integrates and employs the current system within their Internet-based publication to distribute and/or publish the Advertisements through Internet-based media with the intention to drive phone calls from Prospects to Advertisers.

Embedded client software programs: software programs that comprise part of a Web site and that get downloaded into, and executed by, the browser.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Server host: a computer on the Internet that hands out Web pages through a Web server program.

Phone Call Lead: an incoming call from a Prospect to an Advertiser through the system.

Phone-Link: a system-generated URL and sometimes icon that can be used to initiate, from the Internet, the connection of two parties over standard publicly-switched telephone lines.

Prospect: a potential customer of the Advertiser.

Publisher: a company or entity that publishes content or services for consumers and often generates revenue by publishing advertisements within, alongside or as part of said content.

Single-Click Activator Link: a graphical or text icon that is linked to this system's database, embedded into this system's Advertisements, and empowered by a unique batch of computer code that enables the immediate telephonic contact between the Advertiser and the Prospect.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Visit: a series of requests to a fixed Web server by a single person (through a browser), occurring contiguously in time.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows a diagram of the system of the current invention;

FIG. 2 shows the process of connection and interaction between a prospect and an advertiser through the telephone-based pay-for-performance Internet advertising model as designed and dictated by the prior art;

FIG. 3 shows the process of connection and interaction between a prospect and an advertiser model as designed and dictated by the current invention;

FIG. 4 displays the Advertiser's Phone Link Creation function page in the system's Internet-based interface that facilitates the creation of the unique batch of computer code for the ‘single-click’ call connection advertisement;

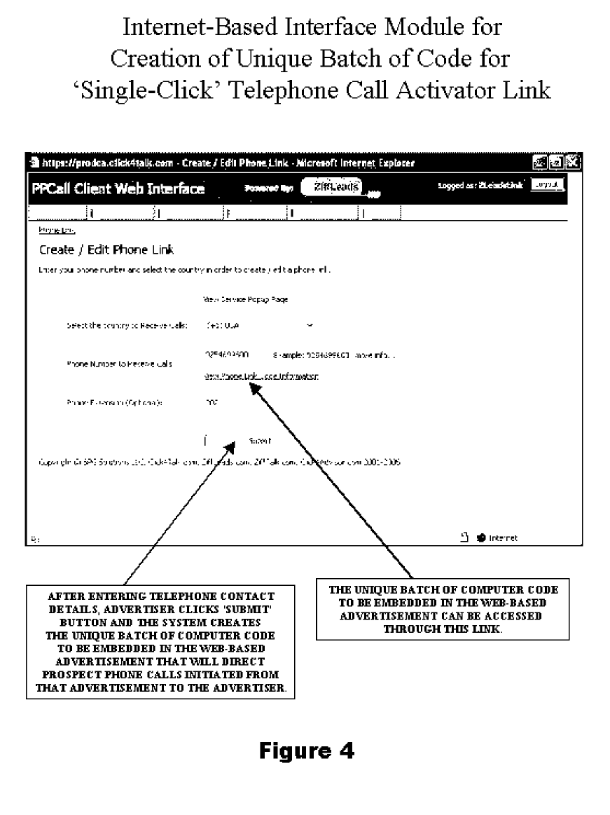

FIG. 5 shows a sample of the Single-Click activator link enabled Advertisements;

FIG. 6 shows a sample of multiple Single-Click activator link enabled Advertisements set in a sample Internet distribution channel; and

FIG. 7 displays a summary page of an Advertiser's Call Activity in the system's Internet-based interface highlighting the Call Source URL.

### DETAILED DESCRIPTION

The following description is demonstrative in nature and is not intended to limit the scope of the invention or its application of uses.

There are a number of significant design features and improvements incorporated within the invention.

The current invention is a system that provides the methods and techniques to create, generally distribute and display telephone call-based pay-for-performance advertising on Internet-based media for Advertisers, and to monitor, record, and charge these Advertisers for successful phone call leads from Prospects generated from these advertisements. The system improves on the prior art by allowing Prospects to contact an Advertiser on the telephone with a single-click action, in response to viewing an Advertisement published on the Internet. A Prospect will visit a Publisher's web page that is Publishing Advertisements created through and generated from the Inventor's system for the Advertiser. The Prospect will select and contact an Advertiser by simply entering his/her phone number into the Advertisement in the designated field and ‘clicking’ on the ‘single-click’ call activator link within the Advertisement. Once the Prospect ‘clicks’ on the link, the system will automatically initiate an outgoing telephone call to the Prospect and, upon Prospect reception, connect the telephone call to the Advertiser at the Advertiser's pre-determined routing telephone number. Further, the present invention provides the method and techniques for efficiently tracking precisely from which URL address, and therefore from which Publisher, from a multiplicity of publishers displaying an identical advertisement, an incoming call to an Advertiser from a Prospect is generated.

The computer and telecommunications application that includes the Prospect, Client and Publisher interfaces for this invention will henceforth be referred to as “the System 1.” The System 1 is network based and works on an Internet, Intranet and/or Wireless network.

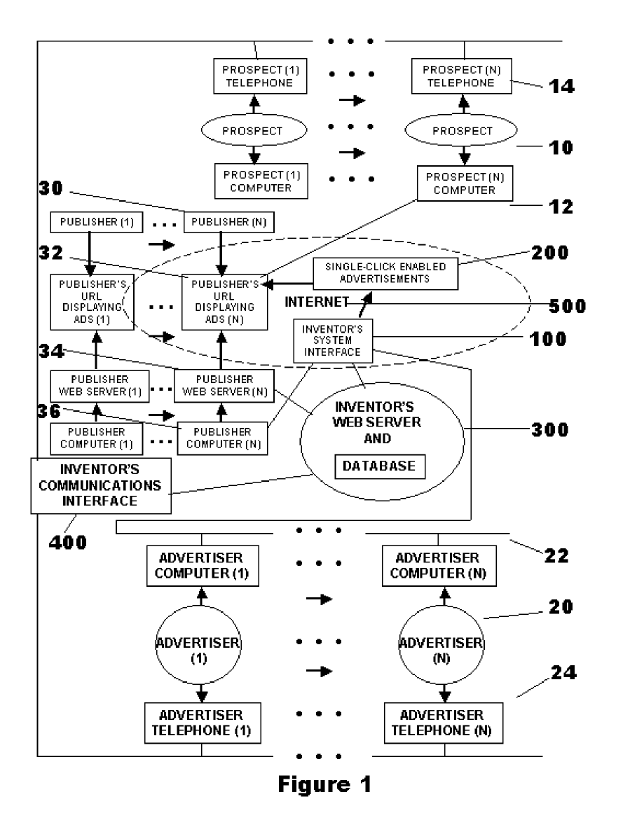

FIG. 1 illustrates a functional diagram of a computer network for World Wide Web (Internet) 500 access to the System 1 by a plurality of Prospects 10 who utilize their Computers 12 and Telephones 14 in order to contact a plurality of Advertisers 20 via the Advertisers' Telephones 24. Prospects 10 access the System's Web Server and Database 300 and the Communications Interface 400 via System-generated Internet-based ‘single-click’ enabled Advertisements 200 that are published by a multiplicity of Publishers 30 through their various web pages (URLs) 32. Accessing the Advertisements 200 can be accomplished directly through a communication means such as a direct connection, an intranet, a local Internet Service Provider, often referred to as ISPs, or through an on-line Service Provider like America Online or Wireless devices using services like AT&T or Verizon.

The Prospects 10 contact the System Web Server and Database 300 via the Advertisements 200, and the Advertisers 20 and Publishers 30 contact System Web Server and Database 300 via the System Interface 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000 or Linux, running a Web browser. The exact hardware configuration of computer used by the Prospects 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, per FIG. 1, the Publishers 30 and Advertisers 20 will be able to connect to the System Interface 100 via the Internet 500 using their respective Computers 36 and 22 to register their accounts; and Prospects 10 will be able to connect to the Advertisements 200 from the Inventor's Web Server 300 as displayed in the Publishers' URL 32 via the Internet 500 using their respective Computers 12 to initiate a telephone call. In the preferred embodiment the System Interface 100 has numerous web pages. The information in the web pages is in HTML format via the HyperText Transport Protocol (http) and on the Server System 300. The System will allow the viewing of web pages and the inputting of Prospect 10, Advertiser 20 and Publisher 30 information to be stored in the System Database 300, through a Web Browser. The system is capable of accessing web pages located on Server System 300.

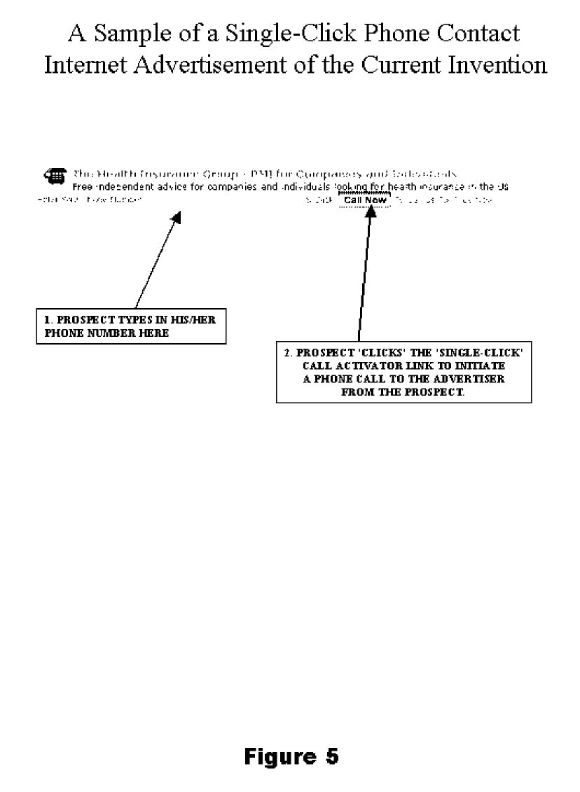

The System 1 will provide the ability to feed multiple Advertisements 200 created by the System for the Advertisers 20 to multiple Publishers 30 for display on multiple Publisher web pages (URL addresses) 32 generated by a combination of the Publisher's web server 34 and the Inventor's web server 300. The Advertisements 200 will be empowered to access the System Web Server Database 300. From these Internet-based Advertisements 200, Prospects 10 will be enabled to make telephone contact directly with Advertisers 20 via the ‘single-click’ call activator link in the Advertisements 200 (FIG. 5).

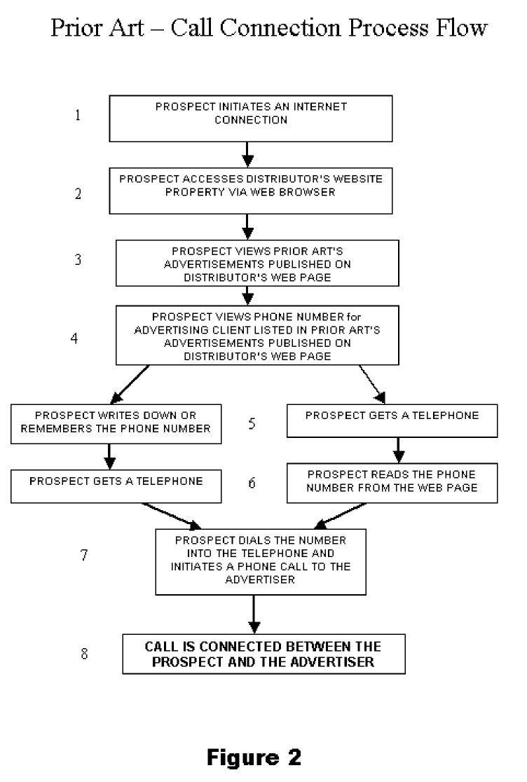

FIG. 2 illustrates the call connection flow of the prior art. The prior art's system and method for connecting a prospect over the telephone from an Internet-based advertisement is cumbersome and in no way leverages the unique tracking capabilities of the Internet or even integrates the service into the Internet interface. Instead, it simply displays a telephone number in an advertisement and requires prospects to do the work the same as if they were to use standard printed Yellow Pages to connect with a merchant-advertiser.

In the prior art, the prospect must detach from the Internet to jot down the phone number, get a telephone (or get a telephone first and read the advertiser's number second), dial the number and then initiate the call. As FIG. 2 shows, after viewing an advertisement generated by the prior art, the prospect must still follow four (4) more steps, all removed from the Internet, to connect to the advertiser, and at last create a successful phone-based pay-for-performance advertising instance.

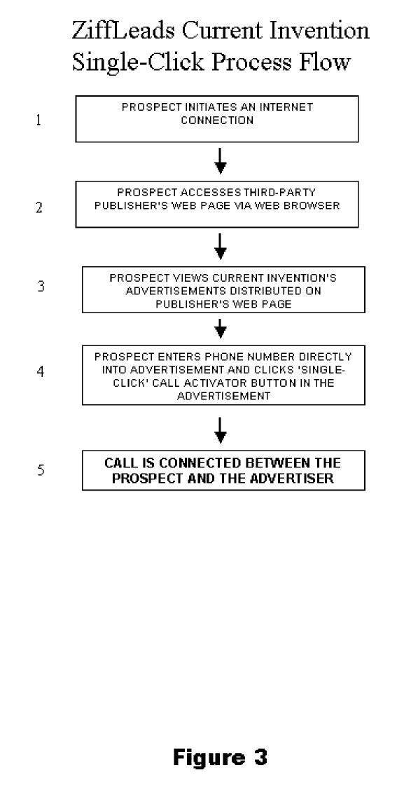

FIG. 3 illustrates the call connection flow of the current invention. The current invention fully integrates the call connection process directly into the Internet-based Advertisement. Prospects view the Internet-based Advertisement, type their number directly into the Advertisement and ‘click’ the ‘single-click’ activator link. Immediately, the System 1 connects the Prospect to the Advertiser by telephone. The current invention is therefore easier and faster than the prior art for Prospects to connect to Advertisers by telephone from Internet-based advertisements.

Per FIG. 1, the System 1 will connect the Prospect 10 and the Advertiser 20 using the Communication Interface 400. In the preferred embodiment, when a Prospect 10 decides to contact an Advertiser 20, the Prospect types his/her telephone number directly into the Advertisement 200 and ‘clicks’ a ‘single-click’ call activator link, also in the Advertisement 200. The call activator link may take the form of a ‘Call Now’ call-to-action graphical image as in FIG. 5, but while the function of the link remains consistent the form of the link may vary. The Communication Interface 400 will then immediately call the Prospect's telephone 14 and the Advertiser's telephone 24 and connect them, thereby providing the opportunity for the Advertiser 20 to turn the new Prospect 10 into a customer.

The System 1 will track and log the details of each such call and display these details in the System's Internet-based Interface 100. The System 1 will charge the Advertiser 20 for the Advertisement 200 in terms of the successfully connected telephone call at a pre-determined rate set in the System 1, and thereby empowering an Internet-based, telephone-measured pay-for-performance advertising model. This communication, in addition to a telephone call through the publicly switched telephone network, can also be done utilizing Voice over Internet Protocol or via an ‘instant messaging’ or ‘short messaging service’ system.

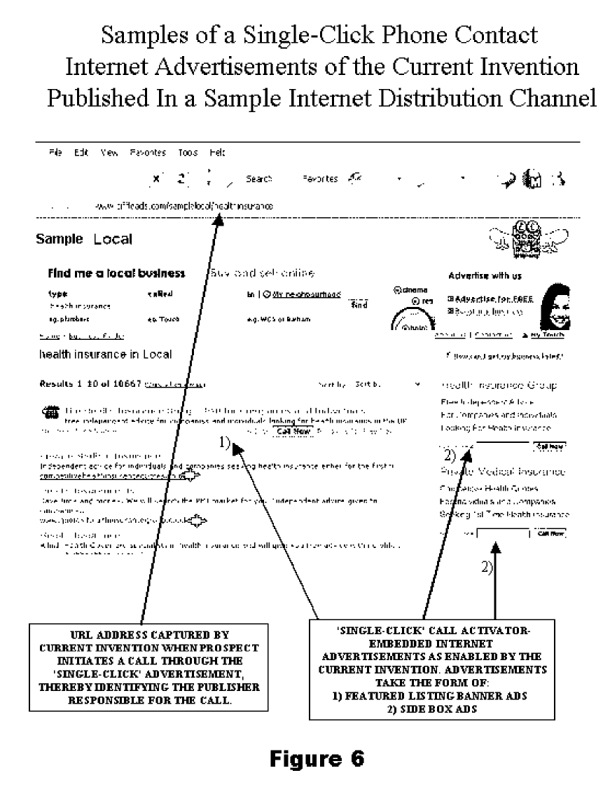

In one preferred embodiment of the invention, Advertisers 20 will register with the System 1 by entering their account and billing information, and making an initial deposit. Advertisers 20 will be assigned an account ID. Advertisers 20 will connect to the System 1 via the System Interface 100 to access their accounts. Within the Advertiser's section of the System Interface 100, the System 1 will facilitate the creation of a unique batch of computer code, the ‘single-click’ call activator link, for the Advertiser 20 that will be embedded into the Advertiser's unique Advertisement 200, and will route Prospect 10 telephone calls from the Advertisements 200 directly to the Advertiser 20. The Advertisements 200 can take the form of any standard or custom Internet-based advertising format, such as top banner, side banner, small text boxes, or directory listings. Examples of a couple forms of Advertisements 200 as displayed within a Publisher's web page 32 can be found in FIG. 6. The agreed upon pre-determined per phone call lead price will be assigned to the Advertiser account in the System 1.

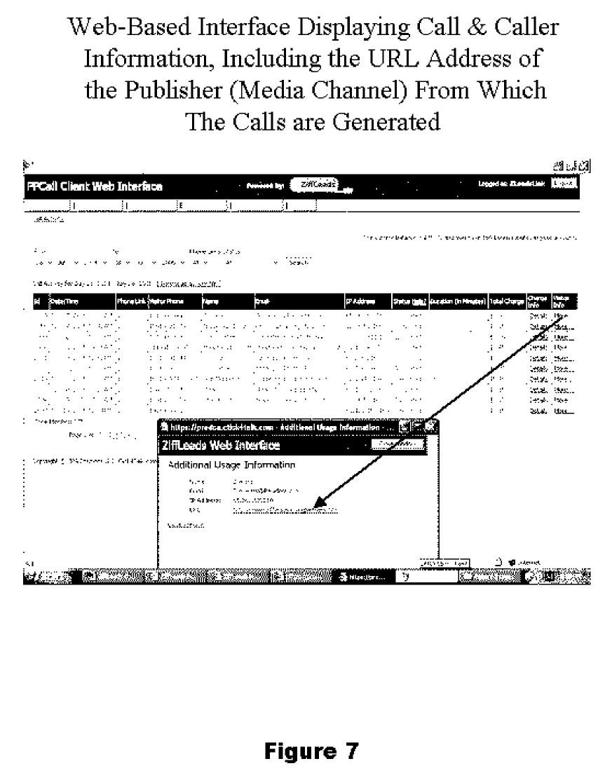

In this preferred embodiment, an Advertiser's 20 unique Advertisement 200 can be distributed and published through an unlimited number of unique Publishers 30 and unique Publisher web pages (URL addresses) 32. When a Prospect 10 ‘clicks’ on the ‘single-click’ call-activator link and connects by telephone to the Advertiser 20, the Prospect's 10 relevant information will be uploaded to the System 1 server and may be displayed in the Advertiser's 20 Call Activity Log in the System Interface 100 as a new record. The Call Activity Log records will include the unique Phone Call Lead ID number, the Date and Time when the call is initiated by a Prospect 10, the Duration of phone call connection, the Prospect's 10 phone number, the Prospect's IP address, and the Publisher's unique web page URL 32 from which the Prospect 10 initiated the call. A sample of the Call Activity Log is shown in FIG. 7.

In this preferred embodiment, a successful telephone call from a Prospect 10 to an Advertiser 20 through the System 1 will be charged by the System 1 a pre-determined ‘per call’ charge. The ‘per call’ charge can be determined in one of the following ways: the Inventor at his own discretion setting the rate, a partner or agent at his/her own discretion setting the rate, via the Inventor and/or partner/agent negotiations with Advertiser directly, or by way of Advertisers bidding openly amongst one another on the rate. The System 1 will automatically deduct the applicable pre-determined charges from the Advertiser's 20 System account. The details of the charges and financial transactions to the Advertiser 20 will be displayed in the Advertiser's System Interface 100 (FIG. 7).

In this preferred embodiment, the System 1 will capture the web page URL address from where a call is initiated immediately upon the Prospect's initiation of the call by ‘clicking’ on the ‘single-click’ call activator link. In this way, the System 1 automatically identifies which Publisher 30, from an unlimited number of Publishers who may all be publishing precisely the same Advertisement 200 for a particular Advertiser 20, is responsible for bringing which Advertisement-generated incoming telephone call to the Advertiser 20. Since the System 1 will identify which Publishers 30 are responsible for which Prospect calls to Advertisers 20, it will therefore easily and efficiently track, calculate and distribute to the appropriate Publishers 30 the appropriate portion of the per call charges to the Advertiser resulting generated from the Advertisers 20 for the calls.

With the Prior Art, wherein a phone number is listed in the advertisement and a Prospect needs to initiate a call from off the Internet, the only way to know precisely from which Publisher, from a group of Publishers, a Prospect's call to an Advertiser is initiated from is by making available and displaying a unique phone number and therefore creating a unique version of the advertisement for each and every unique Publisher publishing the Advertisement. This is inefficient and un-scalable, both of which the current invention remedies.

The system 1 is set to run on a computing device. A computing device on which the present invention can run would be comprised of a CPU, Hard Disk Drive, Keyboard, Monitor, CPU Main Memory and a portion of main memory where the system resides and executes. Any general-purpose computer with an appropriate amount of storage space is suitable for this purpose. Computer Devices like this are well known in the art and are not pertinent to the invention. The system 1 is set to run on telecommunications sets. Telecommunications sets can include standard landline telephone sets utilizing the Publicly Switched Telephone Network (PSTN) or any variations thereof, any kind of cellular telephone set utilizing any cellular call processing technology, as well as any telecommunications sets utilizing Voice over Internet Protocol (VOIP) voice communications technology. Telecommunications sets like this are well known in the art and are not pertinent to the invention. The system 1 can also be written in a number of different languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of connecting two parties in real time, the method comprising:
creating and assigning code to an advertiser, code that when activated will initiate a telephone call to an advertiser's telephone number;
providing advertisement on a plurality of media channels on behalf of an advertiser, the advertisement including the unique batch of code, a field for a prospect to enter a telephone number and an activation link to initiate the telephone call;
generating said telephone call between the prospect and the advertiser upon the prospect activating an activation link embedded into and displayed on the advertisement;
tracking the telephone calls to an advertiser generated from the advertisement displayed in the multiplicity of media channels, and identifying the individual media channel responsible for the telephone call;
and charging the advertiser for said advertisement when said telephone calls are generated through the advertisement.

2. The method as described in claim 1, further including an Internet-based interface.

3. The method as described in claim 2, wherein the Internet-based interface facilitates the creation of the code that will route telephone calls initiated by prospects from the advertisement to the advertiser's telephone number.

4. The method as described in claim 1, wherein the plurality of media channels includes one or more from a group of Internet-based channels of websites, email, instant messaging, short messaging service, personal digital assistant, telephone, and television.

5. The method as described in claim 1, wherein the activator-embedded advertisement can take the form of an Internet-based advertising format.

6. The method as described in claim 1, further including an Internet-based interface to record and display call and caller information captured by the system.

7. The method as described in claim 1, wherein the charging of the advertiser for the telephone call comprises charging a fee that is a combination of a flat fee per call and a per-minute fee.

8. The method as described in claim 1, further comprising determining from which media channel a prospect called the advertiser, and crediting a portion of the advertising fees collected from the advertiser to that media channel.

9. The method as described in claim 7, wherein the media channel from which a telephone call is generated is identified by way of capturing the universal resource locator (URL) address of the web page from which the telephone call is initiated at the time the call is initiated.

10. The method as described in claim 7, wherein the charging of the advertiser for the telephone call comprises charging a flat fee per call.

11. The method as described in claim 7, wherein the charging of the advertiser for the telephone call comprises charging a a per-minute fee.

12. The method as described in claim 7, further including an Internet-based interface to record and display which media channel's advertisement generated the telephone call.

13. A system of connecting two parties in real time, the system comprising:
an initial component that assigns a code to an advertiser, code that when activated will initiate a telephone call to an advertiser's telephone number, and embeds the code into an Internet-ready advertisement;
a secondary component that distributes and displays the advertisement to a plurality of Internet-based media channels;
a third component that initiates and connects a telephone call between a prospect and the advertiser via an activator link embedded in the advertisement;
a fourth component that tracks the telephone call identifying call connection details including the prospect phone number, the advertiser, the time and duration of the call, and the particular media channel from which the call was initiated;
and a fifth component that charges the advertiser for the advertisement in terms of telephone calls generated directly from the advertisement.

14. The system as described in claim 13, wherein the secondary component distributes a single identical advertisement to, and is published by, a plurality of media channels.

15. The system as described in claim 13, wherein the call activator-embedded advertisement can take the form of any standard or custom Internet-based advertising format.

16. The system as described in claim 14, wherein the secondary component identifies the resultant telephone calls generated from various media channels from the advertisement from which the calls are initiated.

17. The system as described in claim 15, wherein the secondary component identifies the media channel from which a telephone call is generated by way of capturing the universal resource locator (URL) address of the web page from which the prospect initiates the telephone call.

18. The system described in claim 13, wherein the secondary component distributes a group of multiple identical advertisements to, and is published by, a plurality of media channels.

19. The system described in claim 13, wherein the third component reads the telephone number entered directly into the advertisement by the prospect and, upon the prospect clicking on an activator link, calls the prospect, calls the advertiser phone number associated with the advertisement, and connects the two parties.

20. The system described in claim 13, wherein the fifth component, in addition to charging the advertiser for the advertisement based on a successful telephone call generated from the advertisement, calculates and distributes a the charges collected from advertiser to the publisher from whose URL address the prospect initiated the telephone call.
